(19) United States
(12) Patent Application Publication
(10) Pub. No.: US 2010/0269428 A1
(43) Pub. Date: Oct. 28, 2010

(54) Cost Effective, Elongate Member Mounting System For Photovoltaic Devices

(76) Inventors: Robert Stancel, Los Altos, CA (US); Martin R. Roscheisen, San Francisco, CA (US); Jeremy H. Scholz, Sunnyvale, CA (US)

Correspondence Address: Director of IP, 5521 Hellyer Avenue, San Jose, CA, 95138, US

(21) Appl. No.: 12/601,240

(22) PCT Filed: May 23, 2008
(86) PCT No.: PCT/US08/64799

§ 371 Date: Jun. 24, 2010

Related U.S. Application Data
(60) Provisional application No. 60/939,843, filed on May 23, 2007.

(51) Int. Cl. E04D 13/18; F16M 13/00; E04B 1/38

(52) U.S. Cl. 52/173.3; 248/309.1; 52/698

(57) ABSTRACT

Methods and devices are provided for improved rooftop solar module mounting assemblies. In one embodiment, an assembly is provided for mounting a plurality of photovoltaic devices over a roof surface. The assembly comprises of a plurality of elongate metal rods, wherein the elongate metal rods are connected together to define a support grid; a plurality of non-roof penetrating grid supports configured to elevate the support grid above the roof surface; and a plurality of grid-to-roof anchors that secure the entire support grid over the roof surface, wherein the number of grid-to-roof anchors is less than about ¼ of the number of non-roof penetrating grid supports to minimize the number of locations where water may enter the roof surface.

### FIELD OF THE INVENTION

This invention relates generally to photovoltaic devices, and more specifically, to cost effective mounting systems for photovoltaic devices or modules.

### BACKGROUND OF THE INVENTION

Solar cells and solar cell modules convert sunlight into electricity. These devices are traditionally mounted outdoors on rooftops or in wide-open spaces where they can maximize their exposure to sunlight. Rooftop mountings are of particular interest in urban settings where open ground is very limited for traditional ground-based installations. Rooftops provide much of the sunlight receiving surfaces in such urban settings and low cost module mountings for such rooftops would drastically increase the number of installations that can be made in such environments.

A central challenge in finding suitable low cost roof mounting for solar cell modules lies in using low cost materials and minimizing the number of roof surface penetrations. Lift-off of solar modules from the roof is possible due to wind, hence weight or locking down/connecting the modules to the roof is desired. As seen in FIG. 1, traditional roof mounts includes roughly one mount 10 per module 12. This creates numerous moisture entry points when such mounts are secured to the rooftop. Each of these entry points needs to be properly sealed to maintain the integrity of the roof and prevent moisture penetration through the roof. The large number of penetrations associated with conventional rooftop mountings creates additional points of failure for the roof and increases the installation time to secure each of the mounts to the roof and seal any and all roof penetrations.

Due to the aforementioned issues, improved rooftop mounting schemes are desired for solar cell modules, and/or similar photovoltaic devices.

### SUMMARY OF THE INVENTION

Embodiments of the present invention address at least some of the drawbacks set forth above. The present invention provides for the simplified installation of solar modules generally, and glass-glass and/or glass-foil solar modules on an existing rooftop. The modules may be framed or frameless. It should be understood that at least some embodiments of the present invention may be applicable to any type of solar cell, whether they are rigid or flexible in nature, flat or rod-shaped, or the type of material used in the absorber layer. Embodiments of the present invention may be adaptable for roll-to-roll and/or batch manufacturing processes. At least some of these and other objectives described herein will be met by various embodiments of the present invention.

In one embodiment of the present invention, an assembly is provided for mounting a plurality of photovoltaic modules over an installation surface. The assembly comprises of a plurality of non-roof penetrating grid supports configured to elevate a support grid above the installation surface.

In one embodiment of the present invention, an assembly is provided for mounting a plurality of photovoltaic modules over a roof surface. The assembly comprises of a plurality of non-roof penetrating grid supports configured to elevate the support grid above the roof surface; and a plurality of grid-to-roof anchors that secure the entire support grid over the roof surface. Optionally, the grid or array comprises of a rigid structure formed by rigidly coupling the plurality of elongate members together. Optionally, the grid comprising a plurality of sections, wherein each section comprises of a plurality of elongate members rigidly connected together.

In one embodiment of the present invention, an assembly is provided for mounting a plurality of photovoltaic modules over a roof surface. The assembly comprises of a plurality of elongate metal rods, wherein the elongate metal rods are connected together to define a support grid; a plurality of non-roof penetrating grid supports configured to elevate the support grid above the roof surface; and a plurality of grid-to-roof anchors that secure the entire support grid over the roof surface, wherein the number of grid-to-roof anchors is less than about ¼ of the number of non-roof penetrating grid supports used to support the modules to minimize the number of locations where water may enter the roof surface.

Any of the embodiments herein may adapted with one or more of the following features. In one embodiment, the elongate member or metal rods comprises of reinforcing steel bars (rebar). Optionally, the elongate member or metal rods comprises of ribbed steel bars. Optionally, the elongate member or metal rods comprises of solid cylindrical metal bars, approximately ⅛-3 inch diameter, made in varying lengths from 4′ to 20′. Optionally, the elongate member or metal rods are epoxy coated. Optionally, the support grid is defined by a plurality of metal rods arranged longitudinally and a plurality of metal rods arrange latitudinally. Optionally, the support grid comprises of a rectangular array. Optionally, the non-roof penetrating grid supports are located at intersections of longitudinally oriented metal rods and latitudinally oriented metal rods. Optionally, the non-roof penetrating grid supports each include a substantially flat bottom surface to engage the roof surface. Optionally, the non-roof penetrating grid supports each include a first cutout to receive a longitudinally oriented metal rod and to a second cutout to receive a latitudinally oriented metal rod. Optionally, the non-roof penetrating grid supports are adjustable in height to address undulations in the roof surface while maintaining the support grid in a substantially flat configuration. Optionally, a plurality of photovoltaic device mounts to secure the photovoltaic devices over the support grid. Optionally, the photovoltaic device mounts are mounted on the on-roof penetrating grid supports. Optionally, the photovoltaic device mounts are mounted on the elongate metal rods that define the support grid. Optionally, the photovoltaic device mounts are configured to engage two separate photovoltaic devices by securing one edge of one photovoltaic device and one edge of a different photovoltaic device. Optionally, the photovoltaic device mounts clamp the photovoltaic device between one surface on the mount and one surface on the non-roof penetrating grid support. Optionally, the photovoltaic device mounts connect the modules to the mounts using hinge connectors to allow for angular motion of the photovoltaic devices. Optionally, the photovoltaic device mounts connect the modules to the mounts using press-fit connectors. Optionally, the photovoltaic device mount comprises of an elevated section so that each photovoltaic device is mounted at an angle relative to horizontal. Optionally, elongate members in one axis are spaced and/or aligned to position support members over the roof support members while elongate members in another axis are aligned and/or spaced to allow for coupling with module attachment members.

A further understanding of the nature and advantages of the invention will become apparent by reference to the remaining portions of the specification and drawings.

### BRIEF DESCRIPTION OF THE DRAWINGS

FIG. 1 is a schematic showing a traditional solar module mount.

FIG. 2 is perspective view of a solar module mounting array according to one embodiment of the present invention.

FIG. 3 shows an exploded perspective view of a support member for use with elongate members according to one embodiment of the present invention.

FIGS. 4 through 6 show various embodiments of module attachment devices according to embodiments of the present invention.

FIGS. 7 though 8 show other support members for use with elongate members according to embodiments of the present invention.

FIGS. 9 and 10 show side views of embodiments of module attachment devices that angle the modules.

FIGS. 11 and 12 show cross-sectional views of a rooftop and support members mounted over support beam according to embodiments of the present invention.

FIG. 13 shows a set of support members with flexible connectors according to one embodiment of the present invention.

FIG. 14 show mounting of modules according to one embodiment of the present invention.

FIGS. 15 and 16 show attachments techniques according to embodiments of the present invention.

FIGS. 17 and 18 show support member for use with the module according to embodiments of the present invention.

FIGS. 19 and 20 show techniques for securing elongate members to the support member according to embodiments of the present invention.

FIGS. 21 through 23 are side views of various support members with height adjustment according to embodiments of the present invention.

FIG. 24 shows various techniques for mounting modules to the array according to embodiments of the present invention.

FIG. 25 shows various techniques for mounting modules to the array according to embodiments of the present invention.

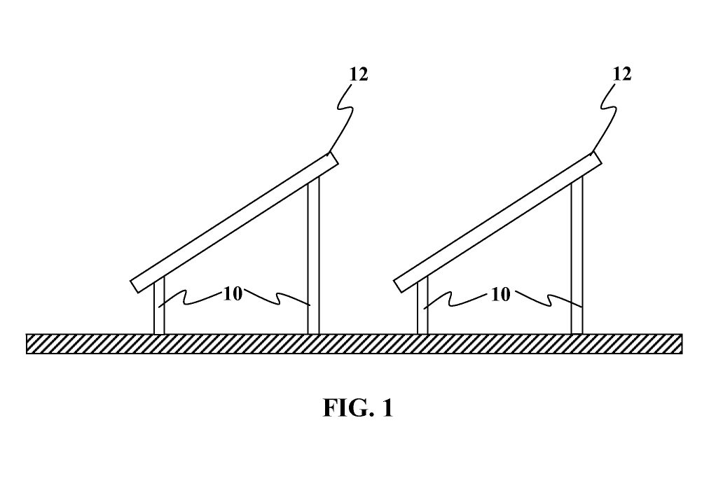

### DESCRIPTION OF THE SPECIFIC EMBODIMENTS

It is to be understood that both the foregoing general description and the following detailed description are exemplary and explanatory only and are not restrictive of the invention, as claimed. It may be noted that, as used in the specification and the appended claims, the singular forms “a”, “an” and “the” include plural referents unless the context clearly dictates otherwise. Thus, for example, reference to “a material” may include mixtures of materials, reference to “a compound” may include multiple compounds, and the like. References cited herein are hereby incorporated by reference in their entirety, except to the extent that they conflict with teachings explicitly set forth in this specification.

In this specification and in the claims which follow, reference will be made to a number of terms which shall be defined to have the following meanings:

“Optional” or “optionally” means that the subsequently described circumstance may or may not occur, so that the description includes instances where the circumstance occurs and instances where it does not. For example, if a device optionally contains a feature for an anti-reflective film, this means that the anti-reflective film feature may or may not be present, and, thus, the description includes both structures wherein a device possesses the anti-reflective film feature and structures wherein the anti-reflective film feature is not present.

### Photovoltaic Device Mounting System

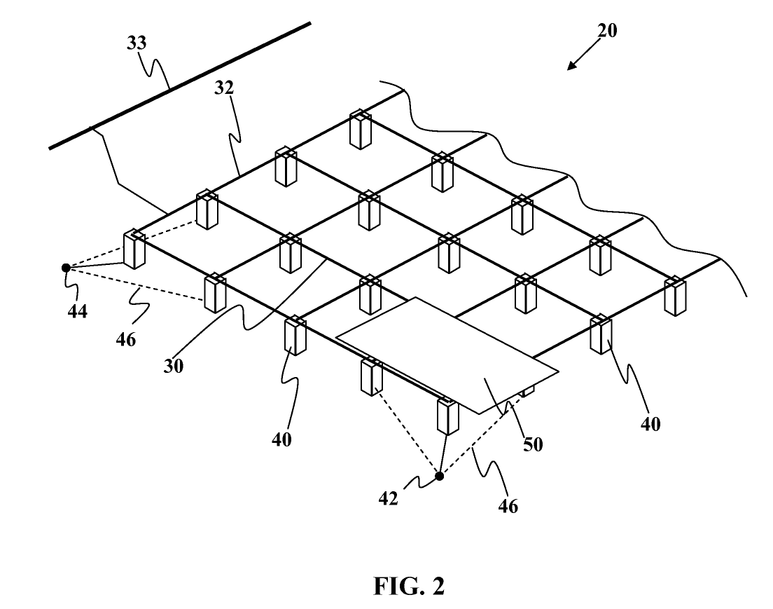

Referring now to FIG. 2, one example of a rooftop mounting device 20 with a simplified installation technique will now be described. This embodiment shows a plurality of latitudinal elongate members 30 and longitudinal elongate member 32 joined together to define an array. In the present embodiment, the array is a rectangular array. It should be understood of course that different types or shapes of arrays (square, rectangular, triangular, oval, hexagonal, etc. . . . ) may be used as desired, singly or in combination, to define the appropriate shape to cover the rooftop in a desired manner. It should also be understood that some rooftops or other mounting locations may use one or more arrays that are structurally connected or not connected together.

By way of example and not limitation, the elongate members 30 and 32 may be comprised of iron bars such as reinforcing steel bar (rebar). Rebar is readily available in standard sizes with diameters from #3 (0.375″ in diameter) through #18 (2.257″ in diameter), lengths of 20′, 40′, and 60′, grade 40 and grade 60. Of course, shorter lengths may also be used. The rebar may be straight, curved, bent, or contain multiple bends as desired for particular installations. The elongate members 30 and 32 may be textured or surface shaped to improve contact with the mounting members. In some embodiments of the present invention, the rebar or other elongate rod material may be bare/non-surface treated, epoxy coated, zinc-plated, otherwise surface treated, or otherwise treated material. Rebar is of particular interest for the present application as it is readily available and is material that most construction crews and contractors are comfortable handling. Optionally, other readily available material may be used for the elongate members such as but not limited to zinc plated conduits, PVC piping, plastics, polymers, metallized polymers, aluminum extension, pretreated wood rods or beams, copper, or other material. These other elongate members may be of cross-sectional shapes such as but not limited to circular, square, rectangular, triangular, other shaped, or single or multiple combinations of the foregoing.

As seen in the embodiment of FIG. 2, these various elongate members 30 and 32 are in contact with support members 40. In this embodiment, the support members 40 may be configured to elevate the elongate members 30 and 32 over the rooftop. Optionally, the support members 40 may be height adjustable to configure the array on the rooftop. Optionally, the support members 40 may be selected to be of a height that configures the array in a substantially planar manner. Optionally, the support members 40 may be selected to be of a height that configures each section of the area is in a substantially planar configuration, wherein different sections may be in different planes, plane angles, and/or plane orientation. Optionally, the support members 40 may be used to connect elongate members 30 and 32 together, with or without elevating them above the rooftop. Optionally in some embodiments, the support members 40 are used merely to align the elongate members together without actually locking the items together. In such an embodiment, this may involve a slidable or other non-rigidly locking coupling. The solar module 50 may be mounted to the array by coupling it to the elongate members 30 and 32. Optionally, the solar module 50 is coupled to the support members 40 to secure them to the array. Still further, some embodiments may use a combination of coupling to the elongate members and the support members. Although not limited to the following, the solar modules 50 in FIG. 2 are shown as being coupled to the support members 40 at non-corner edges of the module. The support members 40 may be made of various materials such as but not limited to metal, polymer, plastics, PVC, injection moldable material, concrete, stone, structural foam material, fiberglass, wood, other building material, or any single or multiple combinations of the foregoing.

FIG. 2 also shows that in the current embodiment, the corners of the array 20 may be secured by grid-to-roof or array-to-roof anchors 42 and 44. Some arrays may have 3 or more anchors. Some embodiments may have 4 or more anchors. Some embodiments may have 10 or more anchors. In one embodiment, anchors 42 and 44 may be mounted at certain distances (regular or irregular) along the perimeter of the array. By way of nonlimiting example, anchors may be spaced at one every two modules along the perimeter. In another embodiment, anchors are spaced at least every 10 feet or other interval along the perimeter. It should be understood that the anchors may be attached to support members 40 along the outer perimeter, those in the rows interior from the perimeter, or a combination of the above. Optionally, the anchors attach to the rods and/or the support members. In some embodiments, there are fewer roof penetrations from the anchors than there are support members 40 used for the array. In other embodiments, there are more anchors positioned outside the perimeter than inside the perimeter of the array. In other embodiments, there are more anchors positioned inside the perimeter than outside the perimeter of the array. In other embodiments, the coupling of anchors may occur by various techniques and may include one or more of the following: adhesives, epoxy, mechanical retainers, weight, screws, bolts, clamps, clips, or combinations thereof. Optionally, the support members 40 used for the array may be attached using various techniques and may include one or more of the following: adhesives, glue, epoxy, mechanical retainers, weight in or on the supper members, screws, bolts, clamps, clips, or combinations thereof. This may be in addition to or in place of the anchors. Optionally, the elongate members 30 and 32 are of such weight that they weight more than the support members and the sheer size, weight, and/or rigid configuration of the elongate members holds the support members in place.

Optionally, it should be understood that the elongate members are all rigidly connect together so that wind loads or other loads are distributed more broadly over the array. This structural rigidly may be due to welds, couplers, or other connectors used to secure the elongate member together. Optionally, it may be due to rigidly from the coupling of elongate members to the structural members 40. Optionally, rigidity in the array may come from some combination of both of the above. In some embodiments, instead of the entire array being entirely rigidly connected, some embodiments may be configured that the array is connected in groups or sections, wherein all the elongate members in each section is rigidly connected, but connections from section to section may be rigid, hinged, slidable, or otherwise connected. Sections may all be of the same size. Optionally, sections may be of at least two different sizes. In one embodiment, the entire support array comprises of two sections. Optionally in another embodiment, the array comprises of at least three sections. Optionally in another embodiment, the array comprises of at least four sections. Optionally in another embodiment, the array comprises of at least five sections. Optionally in another embodiment, the array comprises of at least six or more sections. In one embodiment, the array covers at least about 10000 square feet in area (as measured based on dimensions measured around the array perimeter). In one embodiment, the array covers at least about 15000 square feet in area (as measured based on dimensions measured around the array perimeter). In another embodiment, each section is at least 5000 square feet. In another embodiment, each section is at least 7500 square feet.

The use of the anchors at select locations minimizes the number of moisture penetrating points on the roof surface. Not every module has all of its support members anchored to the roof. With each anchor 42 or 44, there may optionally be additional cabling, attachment rods, or other connector 46 (shown in phantom) to increase the number of support members 40 engaged by each anchor. There maybe one or more connectors 46 for each anchor. In some embodiments, the connectors 46 are coupled to the support members. In other embodiments, they may be coupled to the elongate members 30/32 or a combination of elongate members 30/32 and support members 40. In other embodiments, they maybe the elongate members. FIG. 2 also shows one embodiment for grounding the array 20 may connected to grounding rod(s) 33 on the roof. Optionally, other embodiments may couple the array to other ground elements to direct undesired electrical charges to ground. Grounding elements may be including any and all embodiments disclosed herein.

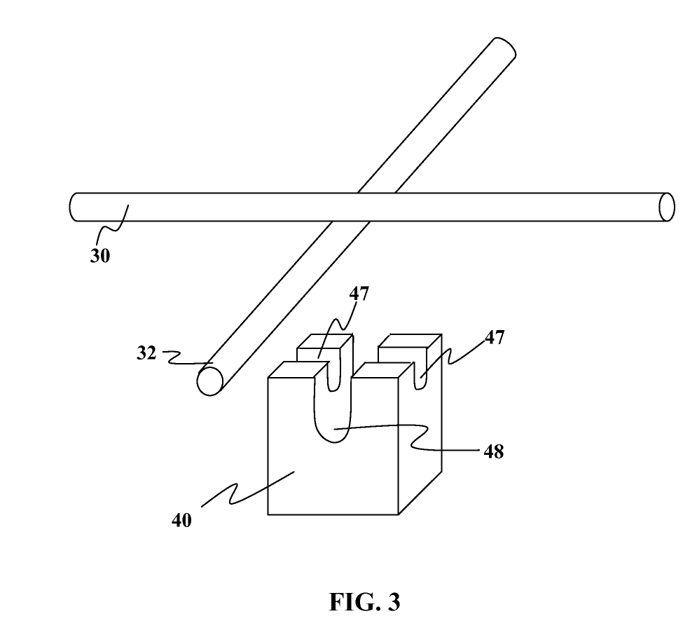

Referring now to FIG. 3, one embodiment of a support member 40 according to the present invention will now be described in more detail. FIG. 3 shows that the support member 40 may include a cavity 47 for receiving one of the elongate members 30 and a cavity 48 for elongate member 32. The cavities 47 and 48 are positioned so that the elongate member 30 is allowed to cross over the elongate member 32. This allows long lengths of the elongate members to be used while engaging multiple support members 40 along the length of the elongate member. With this type of configuration for support member 40, it is preferable that all support members engaging the lower mounted elongate member 32 be put in place before putting the elongate member 30 in place.

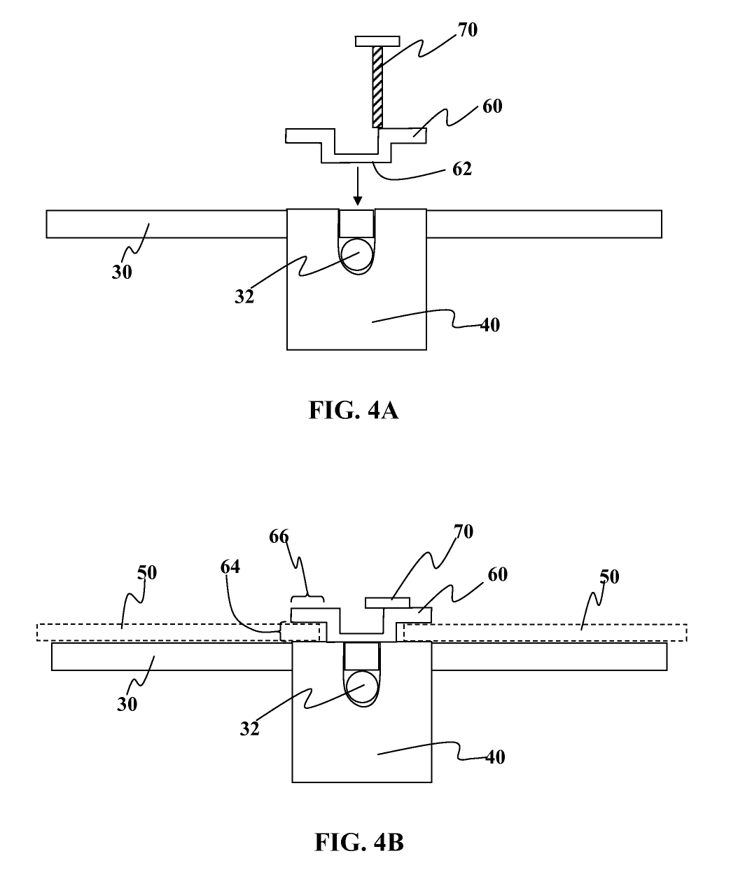

Referring now to FIG. 4A, the support member 40 is shown with one embodiment of a module attachment device 60. This embodiment of the attachment device 60 is configured to be positioned over the support member 40 and designed for the dual duties of a) holding the elongate members in place and b) securing the modules 50 in place. This dual capability will simplify installation. As seen, the installation of a set screw 70 will secure the elongate members 30 and 32 in position in the support member 40. The use of a set screw 70 is purely exemplary and other devices such as but not limited to clamps or compression fixtures may also be used.

FIG. 4B shows the embodiment of FIG. 4A wherein the set screw 70 has been tightened and the attachment device 60 is positioned to secure the module 50 and the elongate members 30 and 32 in place. As seen in FIGS. 4A and 4B, the attachment device 60 cannot be overtightened to the point where it compresses and damages the modules 50. In the present embodiment, the bottom surface 62 of the attachment device 60 will engage an upper surface of support member 40, and this limits any further downward clamping. Even if an installer overtightens the set screw 70 or other fastener, the physical structure of the attachment device 60 is such that a minimum gap 64 is defined between the support member 40 and the underside of overhang 66. This self-limiting tightening feature prevents damage to the modules from the attachment drive 60 during installation.

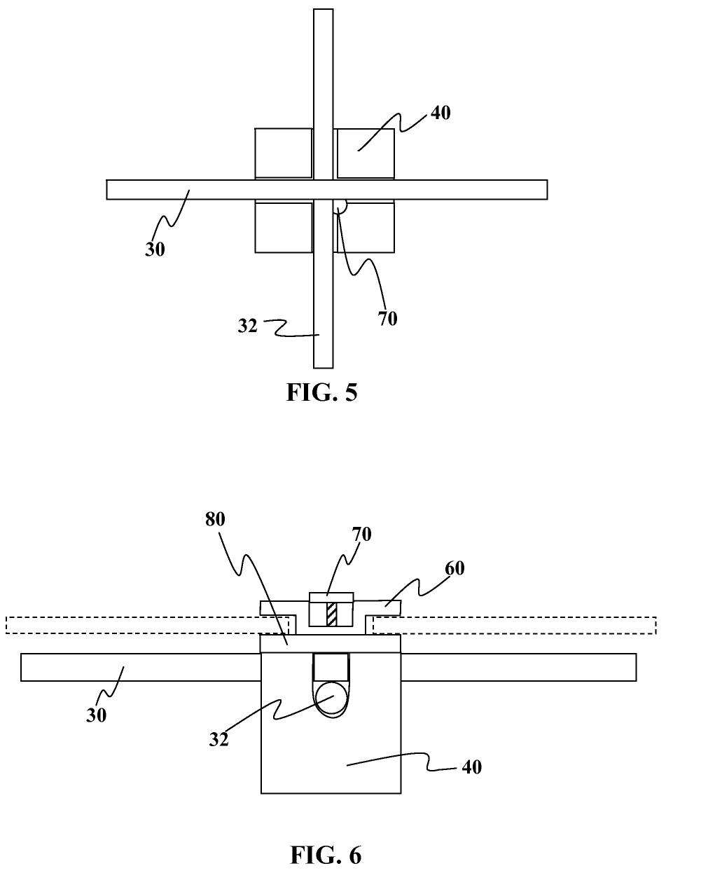

Referring now to FIG. 5, in some embodiments, it is the combination of the set screw 70 and the attachment device 60 that secures the module 50 and elongate members 30 and 32 in-place. As more clearly shown in FIG. 5, the positioning of the set screw 70 is such that, when installed, it provides an interference/compression fit with the elongate members 30 and 32 in the support member 40. In some embodiments, it is desirable that the set screw 70 be comprised of a material harder than that used in the elongate members 30 and 32 to facilitate engagement or bite of the set screw against the elongate members. In addition to the set screw, the attachment device 60 prevents the elongate members 30 and 32 from escaping upward as the set screw 70 is tightened. In this manner, the combination of the set screw 70 and the attachment device 60 holds the elongate members in place. The attachment device 60 can also perform its standard duties of holding the module 50 between one surface of the attachment device 60 and one surface of the support member 40. It should be understood that one or more surfaces of the device 60 and/or member 40 may be covered with rubber, polymeric material, or other compliant material to facilitate non-damaging engagement with module 50.

Optionally as seen in FIG. 6, a separate attachment device 80 is mounted on the support member 40 to secure the elongate members 30 and 32 while the attachment device 60 is used only to secure the modules 50 to the support member 40. In this embodiment, the elongate member attachment device 80 is used to first separately secure the elongate members 30 and 32 in place at the support member 40. This separation of attachment devices allows the entire grid array or large portions of it to be constructed and secured first. After the grid array is laid out and secured, the modules 50 may be attached at a later point in time. This separation of duties may optionally allow for different installation personnel to be used (i.e. one crew specializing in grid array construction, a second crew specializing in module installation on the array).

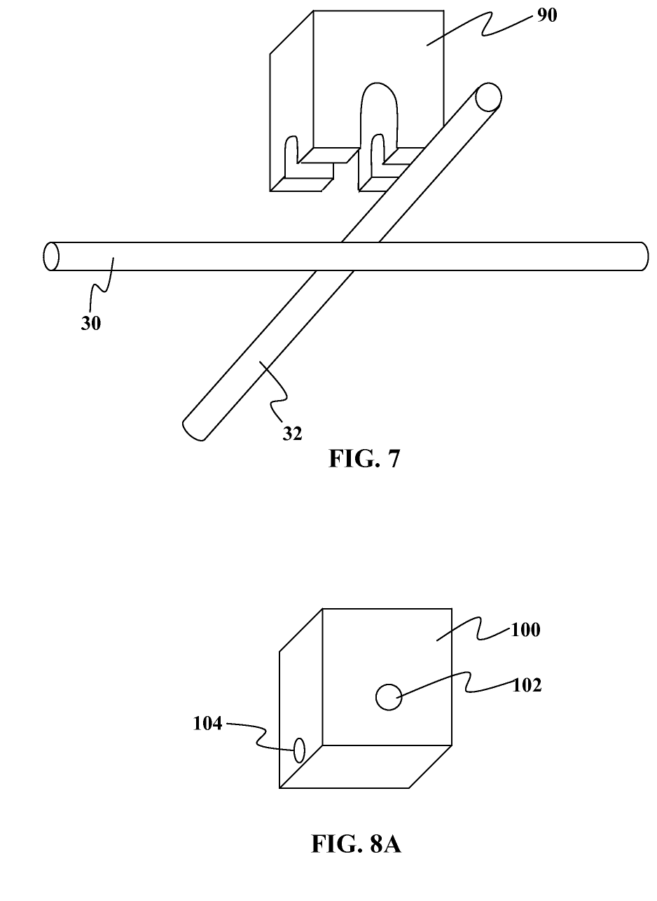

Referring now to FIG. 7, yet another embodiment of the present invention will now be described. This shows that a support member 90 for use with elongate members 30 and 32 when those members are not elevated off the roof. In this embodiment, the support member 90 fits over the elongate members 30 and 32, instead of vice versa. This reduces the loads on the support member as the elongate members 30 and 32 are no longer pushing down on the support member 90. The elongate members 30 and 32 may be lashed together or otherwise joined prior to, during, or after placement of the support member 90. The support member 90 may be secure to the elongate member by clamps, set screw, adhesive, or other attachment device or technique.

Referring now to FIG. 8A, a still further embodiment of a support member according to the present invention will now be described. The support member 100 is shown as having openings 102 and 104. The elongate members 30 and 32 will slide into these openings 102 and 104, passing through the member 100, and then out the other side. This configuration is advantageous in that no additional pieces are used to secure the elongate pieces 30 and 32 from moving vertically inside the member 100. This may simplify installation during construction of the grid array. It should also be understood that some embodiments may add a foam material to the rooftop to secure the modules and/or array in place. In one embodiment, foam may be used on all or only portions of the array. In some embodiments, the foam is provided at a depth and coverage to secure all or a portion of the support members 40 in place. In some embodiments, these support members 40 are positioned without attaching them to elongate members 30 and 32, but instead, foam is used to secure the members in place. The modules may be mounted before or after foam deployment. In some embodiments, the foam may be used to secure both the support members 40 and the modules 50. Optionally, the foam may be a roofing foam. In some embodiments, it may be an insulating foam. Others, it may simply be a foam that expands into a hardened or compliant configuration.

Referring now to FIG. 8B, yet another embodiment is shown where one elongate member uses a hole 104 while the other uses a groove 110. This allows one elongate member to hold the other one in position.

Referring now to FIG. 8C, a still embodiment is shown where one elongate member uses two cut-outs 120 and 122. The cut-outs are oriented to come from opposite directions. Cut-out 120 has an upward facing opening while cut-out 122 has a downward facing opening. Again the elongate members 30 and 32 may be positioned to lock the other in position. In this embodiment, the elongate member in the update facing cut-out is positioned beneath the elongate member in the downward facing cut-out 122.

### Angled Module Mounts

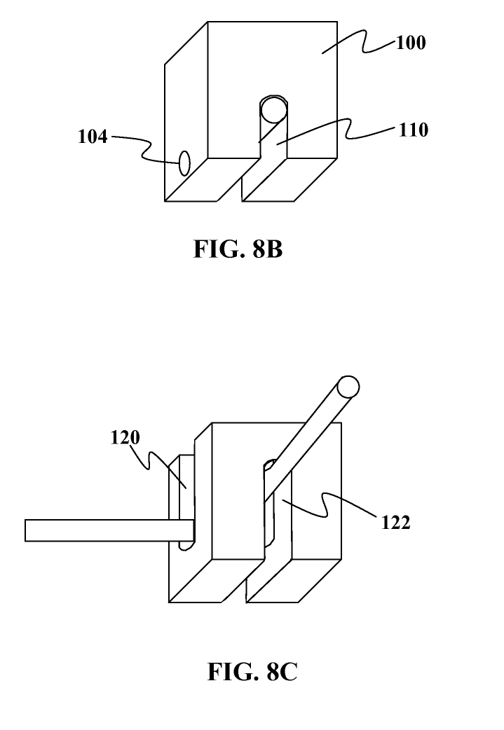

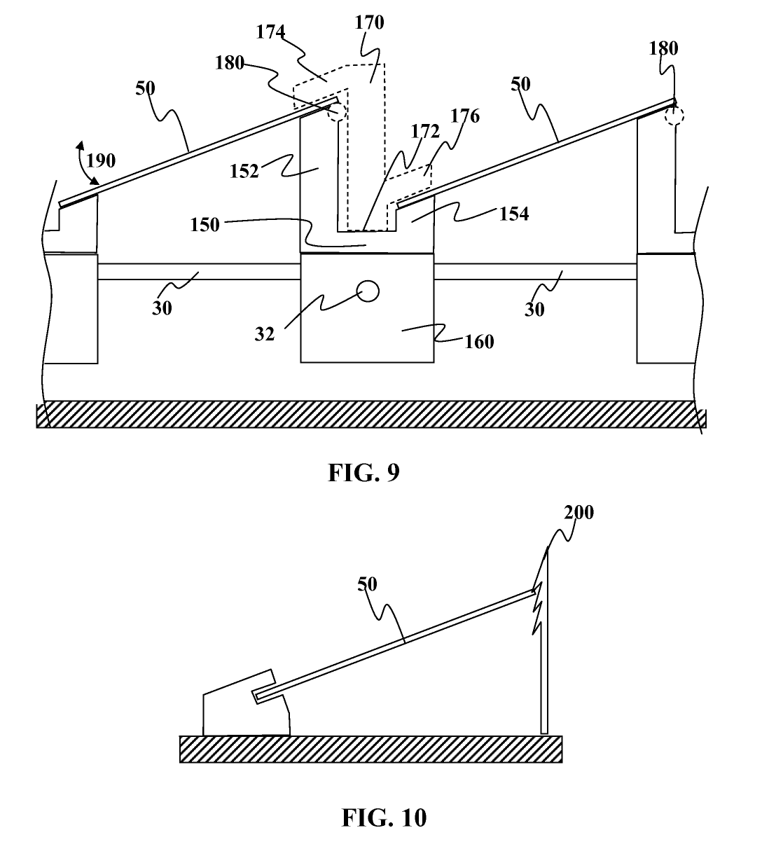

Referring now to FIG. 9, another embodiment of the present invention will now be described. FIG. 9 shows how the modules 50 may be mounted to be in an angled orientation relative to the roof surface. In FIG. 9, a modified attachment device 150 is mounted over a support member 160. The attachment device 150 includes supports at two different heights. The first support 152 is provided to support the high end of a module 50 while a second support 154 is used to support the low end of another module 50. Thus, even though the array 20 is in a substantially planar configuration, the modules 50 mounted above the array 20 may be configured.

A module clamp 170 (shown in phantom) may be secured to the attachment device 150 to hold the modules 150 in place. Again, the module clamp 170 is designed so that overcompression is not possible. A bottom surface 172 is selected so that a minimum vertical spacing is maintained in the areas such as overhangs 174 and 176 where the clamp 170 will compress against the modules 50.

Optionally, instead of being rigidly secured in place on the attachment device 150, the modules 50 may be hinged by way of hinge attachments 180 (shown in phantom) on the module attachment devices 150. The hinge attachments 180 allow the modules 150 to swing free at one end as indicated by arrows 190. This allows for excess wind forces to be released, instead of putting strain on the entire array 20 and possibly lifting the array off the roof surface. It should be understood that a various types of hinges may be used and the present invention is not limited to any particular hinge. By way of nonlimiting example, the hinges may be living hinges of polymer(s), metal foil, and/or textile material.

FIG. 10 shows yet another embodiment of an attachment device 200. This uses a ratchet type system wherein the module 150 is pushed downward and held in place by teeth or retaining protrusions on the attachment device 200. This allows for quick clamping action and facilitates the installation process.

Alignment with Roof Mounts

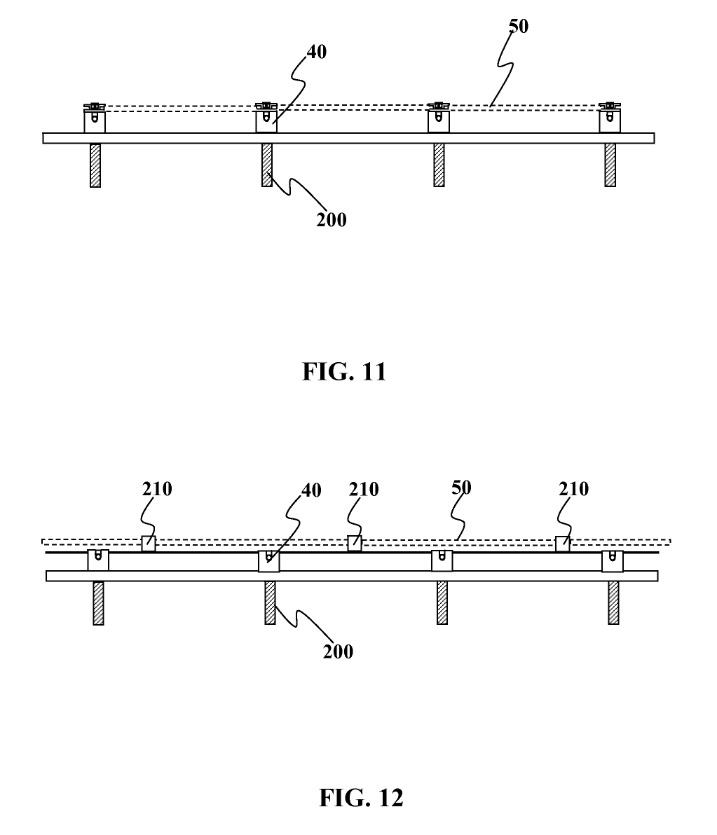

Referring now to FIGS. 11 and 12, it is shown that embodiments of the present invention may be configured to align the support members 40 with underlying, weight-bearing roof support beams 200. Depending on local construction codes, roof structures may have varying weight bearing strength in the material spanning between support beams 200. Some may be sufficient support the weight of humans walking over them, while others may be more fragile. To minimize the risk of damage to the rooftop, it is desired in some embodiments to align the support members 40 over the weight-bearing beams or elements 200 as seen in FIG. 11. This type of configuration allows for installment of the solar modules in manner that focuses load on the stronger structures in the roof. Some embodiments may have members 40 over every beam. Other may have support members 40 over only every other beam or some other spacing where not every beam is carrying load from an overlying support member 40. Some embodiments may be such that the elongate members in one axis are aligned over support beams in the underlying roof while the elongate members in the cross axis are not specifically aligned over the support beams but are aligned to best support the modules. In some embodiments, the entire array is such that the elongate members are not specifically mapped to the modules, but are mapped to the underlying support structure in the roof.

Referring now to FIG. 12, it should be understood of course, that sometimes the spacing of the beams 200 may be such that they are not spaced in a manner (e.g. too far apart, too close together, etc. . . . ) that does not readily allow for the alignment of beam to support member as shown in FIG. 11. In this embodiment, the positioning of modules 50 over the array is independent of the position of the underlying support member 40 over beams 200. The modules are coupled to attachments 210 that may attach to elongate members 30 and 32 and thus are not fixed to the specific locations of the support member 40. The spacing of attachments 210 is not restricted by the support member 40. Optionally, the attachments may be mounted other supports between members 40 and not coupled to the elongate members 30 and 32.

### Non-Rigid Embodiments

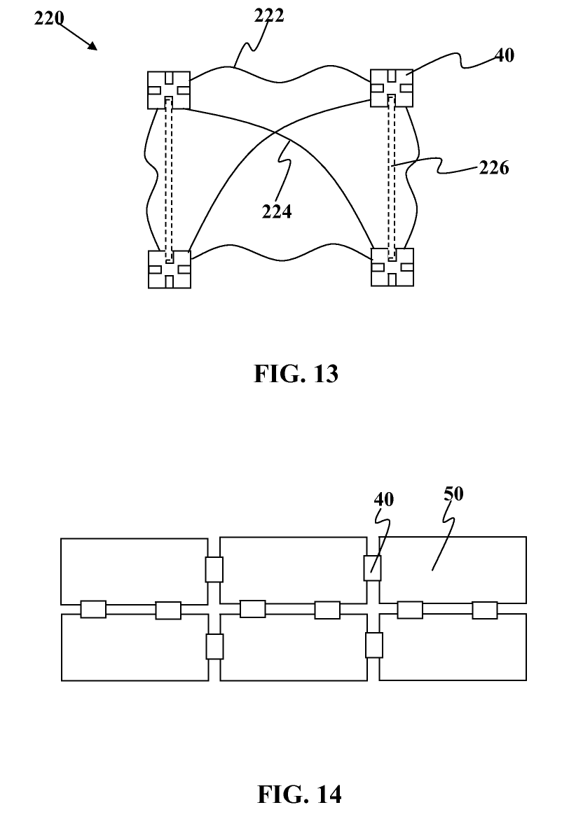

Referring now to FIG. 13, yet another embodiment of the present invention is now described. In this embodiment, instead of having each support member 40 as an independent unit, the assembly 220 is shown where four support members 40 are joined by flexible connectors 222. Although not limited to the following, the connectors 222 may be such that they allow the support members 40 to be moved closer together, but not stretched beyond a length defined by the connectors 222 (i.e. flexible, but not stretchable). Optionally, a center crisscross connector 224 may be included if it is desired that the assembly 220 form a square, rectangle, or other shape with particular aspect ratios. After positioning on the rooftop, modules 50 may be coupled to the members 40 to lock them into position. Optionally, some embodiments of assembly 220 may use rods 226 to maintain a desired spacing between members after they are laid out on the rooftop. In still further embodiments, foam or other material may be used to the secure the support members 40 in place after they are initially deployed and spaced based on the flexible connector. For ease of illustration, only four support members 40 are shown. It should be understood, however, that embodiments with 6, 8, 10, 12, 14, or entire arrays may be formed with flexible connectors therebetween to simplify position of the members during installation. Optionally, the connectors 222 and/or 224 may be removed once the members 40 are locked into position.

FIG. 14 shows an embodiment where the spacing between support members 40 is maintained by the boundaries defined by the modules 50. The modules 50 act both as the photovoltaic member and the structural elements between the support members 40 to define the array. The support members 40 may be individual members or those that are part of an array similar to that shown in FIG. 13.

### Module Attachment Techniques

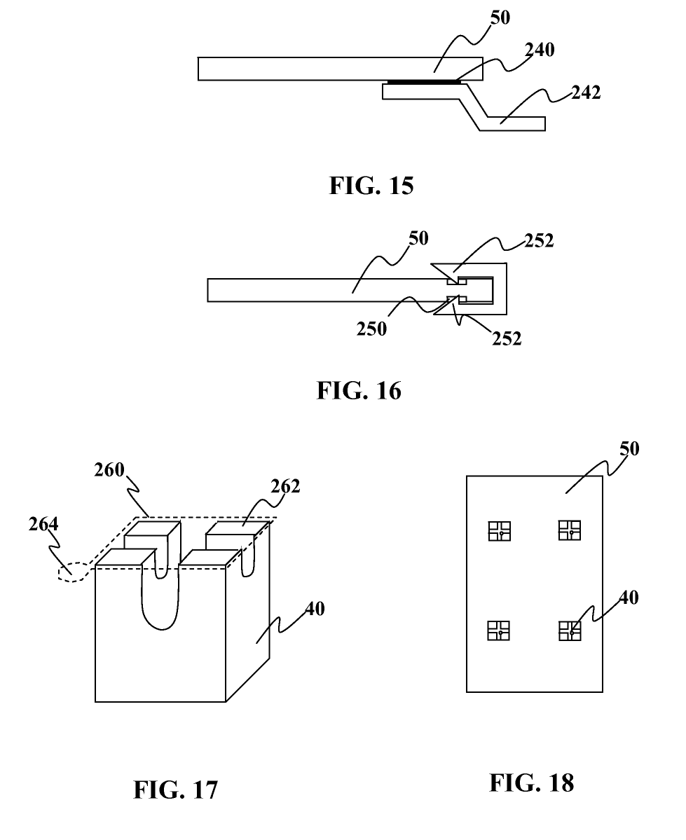

Referring now to FIGS. 15 and 16, various module-to-support member attachment techniques will now be described. FIG. 15 shows that an adhesive material 240 may be used to secure the module 50 to a bracket 242. In some embodiments, instead of bracket 242, the adhesive may be used with the module support member 40 (see FIG. 17). Some embodiment of the adhesive may be a metal to glass adhesive such as but not limited to a material available from Dymax Corp. Some adhesives may be rigid in nature and provide no compliance. Optionally, some adhesives may be selected that remain pliable even while maintaining the bond between the module 50 and bracket 242.

Referring now to FIG. 16, this embodiment shows that the module 50 may itself be shaped with one or more trenches or indentations 250 sized to match barbs or protrusions on a bracket 252. This allows for mechanical retention of the module to the bracket 252. Optionally, adhesive may also be used with the mechanical retention technique. Some embodiments may include only groves, trenches, or indentations on one or both sides. Some embodiments may use a combination of indentations and protrusions on the module 50. The modules 50 with protrusions may be sized to match indentations or grooves on the bracket and vice versa.

Referring now to FIG. 17, it is shown that in this embodiment of the present invention, a single protective layer 260 (shown in phantom) is used with the module support member 40 to protect the adhesive surfaces 262 thereunder prior to use. Some embodiments may use more than one protective layer depending on how many surfaces are to be covered. A tab 264 is provided for easy removal of the layer 260.

FIG. 18 shows that for embodiments attaching to the underside of the module 50, the support members 40 may be mounted away from the edges of the module 50. FIG. 18 shows that the support members 40 are located beneath the module, closer to the midline areas of the module. Although not limited to the following, this placement again frees up positioning of the module 50 independent of the position of the support members 40.

### Elongate Member Attachment Techniques

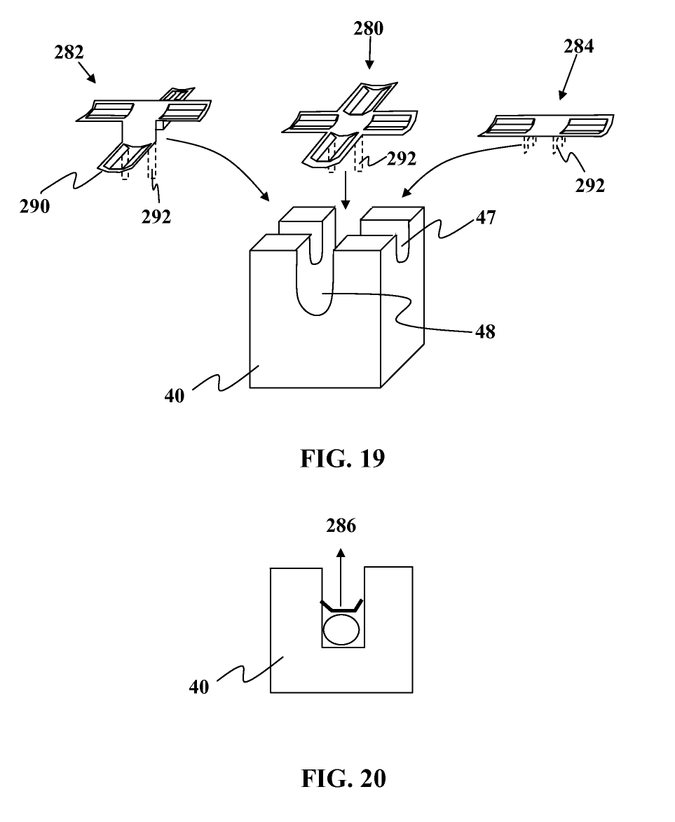

Referring now to FIGS. 19 and 20, yet another embodiment of the present invention will now be described. As seen in FIG. 19, the elongate members that fit in cut-outs or recesses 47 and 48 may be held in place by shaped retaining members 280, 282, and/or 284. Shaped members 280, 282, and/or 284 as seen in FIG. 20 is curved in a manner that resists removal when pushed upward as indicated by arrow 286. The edges of the shaped members will engage the walls of the support member 40 and resist movement in that direction.

FIG. 19 shows various configurations of the shaped retaining member. Shaped member 280 is cross-shaped to cover all four legs of the cutouts. Shaped member 280 is substantially planar. Shaped member 282 is cross-shaped, but has portions 290 that are more contoured to match the lower position of one set of elongate member passing through the support member 40. Shaped member 284 has a substantially linear shape and is configured to engage one set of the elongate members. These shelf-locking members may be made of metal, metallized polymer, or the like.

As seen in FIG. 19, each of the shaped retaining members 280, 282, and/or 284 may include one or more downward extending legs 292 to cut into the elongate members to hold them in place. The material of these legs may be spring steel or other material with a hardness greater than that of the elongate members. The opening in the legs may be smaller than the cross-section of the elongate members (round or otherwise shaped) so as to engage the members and prevent lateral pull out of the elongate members. One or more may be included with each retaining member. Optionally, more than one retaining member may be used with each support member 40.

### Height Adjustment Techniques

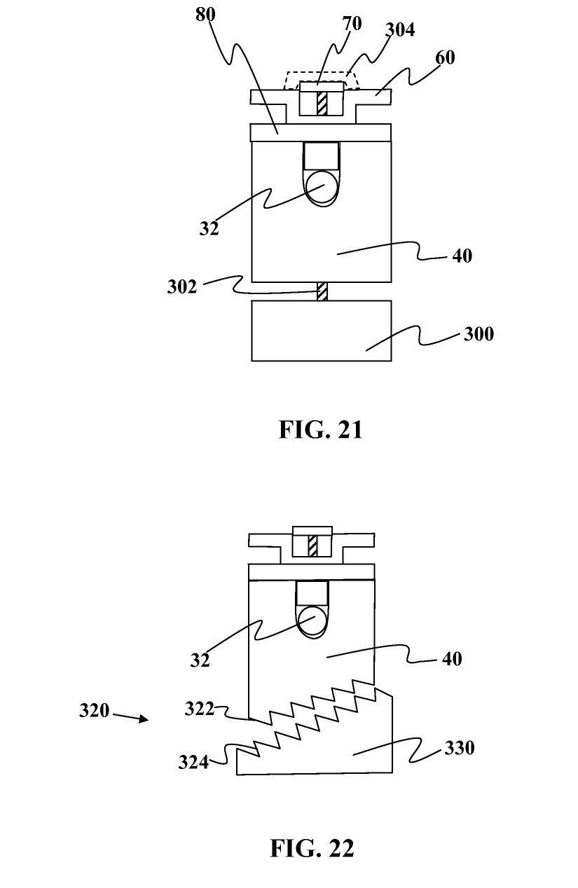

Referring now to FIG. 21, it should be understood that in this embodiment of the present invention, the support 40 may be configured to include a height adjustment mechanism 300. Although not limited to the following, the embodiment of FIG. 21 may use a screw-based mechanism 302 to lower the height adjustment pad to contact the roof top surface. In some embodiments, the screw mechanism 302 is tied to screw 70 such that turning screw 70 not only tightens against the elongate rods, but also deploys the pad the mechanism 300. A restrictor plate 304 (shown in phantom) may optionally be placed over the screw 70 to hold it in place. Of course, in other embodiments, the screw-based mechanism 302 is separate from the screw 70 and is driven by other methods. Other lower mechanism such as but not limited to ratchet based lowering devices and/or quick release clamps may be used to lock the height adjustment pad in place once the appropriate height is determined.

Referring now to FIG. 22, a still further embodiment of the present invention with a height adjustment device 320 is shown. This embodiment of support member 40 includes a stepped lower surface 322 with mates with a stepped surface 324 on a shim 330. The stepped surfaces may be slightly angled relative to horizontal to facilitate locking of the desired positions. The shim 330 is slid into the position that provides the desired height. In some embodiments, smooth shims without the stair stepped surfaces may be used. In some embodiments, more than one shim may be used per support member 40 (i.e. such as but not limited one ship per side of the support member 40).

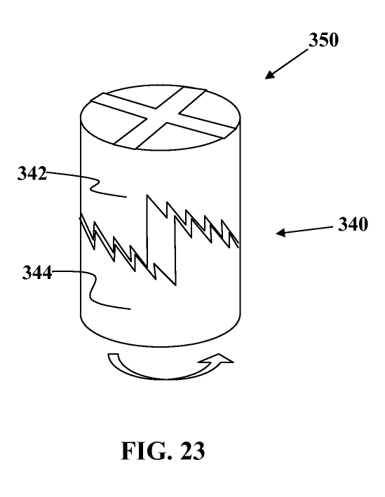

Referring now to FIG. 23, a still further embodiment of a height adjustment device 340 is shown. This embodiment uses a rotary system wherein rotation of the upper portion 342 relative to the lower portion 344 will engage steps of varying height which will in turn adjust the height of the support member 350.

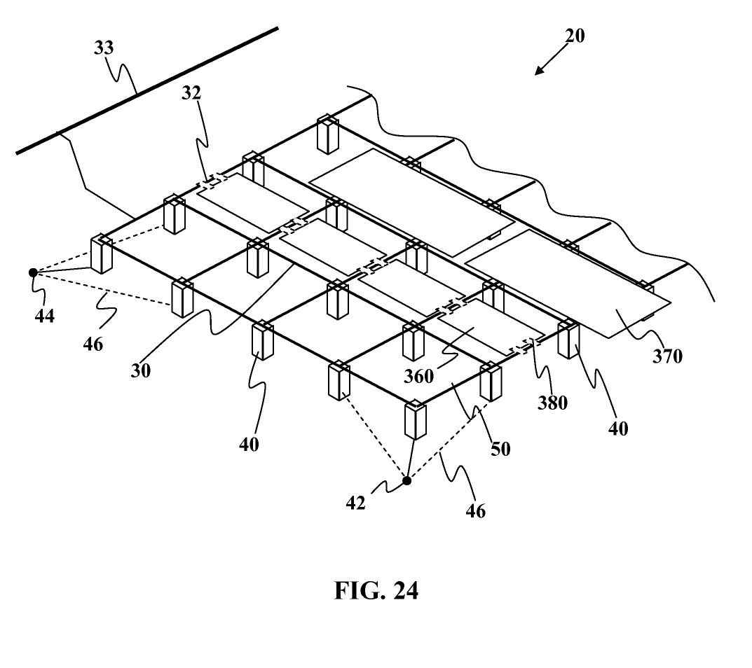

FIG. 24 show one embodiment wherein the array 20 is shown wherein the modules are sized to be coupled between the elongate members as indicated by modules 360. In another embodiment, it is shown that the modules 370 are sized to fit over the elongate members. As seen in FIG. 24, the modules 360 may be mounted to the elongate members in one or both axis. The modules 360 may be connected at the edges by couplers 380 which may be coupled to secure more than one module at a time by spanning over both edges of an elongate member.

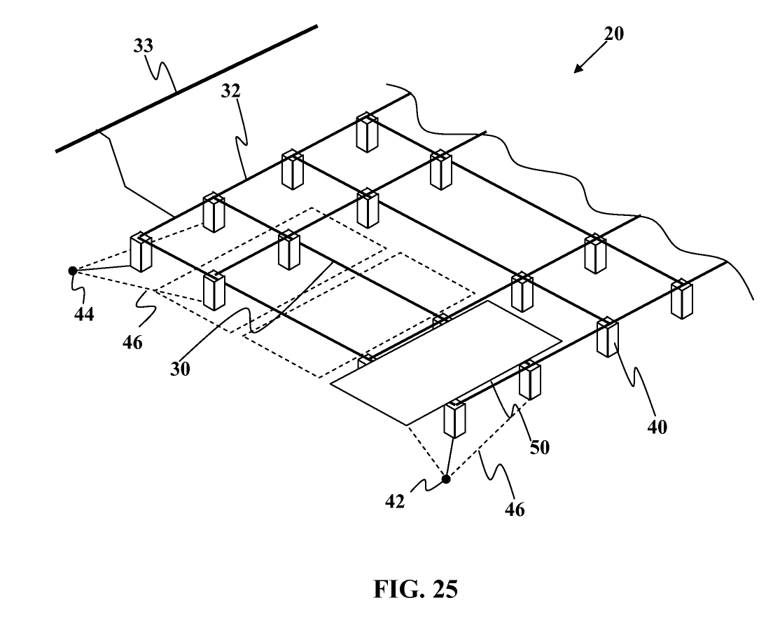

FIG. 25 shows yet another embodiment of an array 400 wherein the elongate members 32 are in one axis and aligned and/or spaced to be positioned over support beams in the underlying roof. The elongate members 30 in another axis are aligned and/or spaced to best support the connection the overlying modules 410. The spacing and/or alignment of the elongate members 30 is different from that of the elongate members 32.

While the invention has been described and illustrated with reference to certain particular embodiments thereof, those skilled in the art will appreciate that various adaptations, changes, modifications, substitutions, deletions, or additions of procedures and protocols may be made without departing from the spirit and scope of the invention. For example, with any of the above embodiments, the modules may be at the module corners instead of along non-corner edges of the module. The modules in the array may be configuration in the same orientation or in different orientations (landscape and/or portrait). The support members and array may be used with framed or frameless modules. Although these support arrays are discussed in the context of roof top mounting, it should be understood that they may also be adapted for use in ground mounted installations or on non-roof mounting areas. The modules may include an anti-reflective layer.

Furthermore, even though thin-film solar cells such as CIGS solar cells are described for the purposes of example, those of skill in the art will recognize that any of the embodiments of the present invention can be applied to almost any type of solar cell material and/or architecture. For example, the absorber layer in solar cell 10 may be an absorber layer comprised of silicon, amorphous silicon, organic oligomers or polymers (for organic solar cells), bi-layers or interpenetrating layers or inorganic and organic materials (for hybrid organic/inorganic solar cells), dye-sensitized titania nanoparticles in a liquid or gel-based electrolyte (for Graetzel cells in which an optically transparent film comprised of titanium dioxide particles a few nanometers in size is coated with a monolayer of charge transfer dye to sensitize the film for light harvesting), copper-indium-gallium-selenium (for CIGS solar cells), CdSe, CdTe, Cu(In,Ga)(S,Se)₂, Cu(In,Ga,Al)(S,Se,Te)₂, and/or combinations of the above, where the active materials are present in any of several forms including but not limited to bulk materials, micro-particles, nano-particles, or quantum dots. The CIGS cells may be formed by vacuum or nonvacuum processes. The processes may be one stage, two stage, or multi-stage CIGS processing techniques. Additionally, other possible absorber layers may be based on amorphous silicon (doped or undoped), a nanostructured layer having an inorganic porous semiconductor template with pores filled by an organic semiconductor material (see e.g., US Patent Application Publication US 2005-0121068 A1, which is incorporated herein by reference), a polymer/blend cell architecture, organic dyes, and/or C₆₀ molecules, and/or other small molecules, micro-crystalline silicon cell architecture, randomly placed nanorods and/or tetrapods of inorganic materials dispersed in an organic matrix, quantum dot-based cells, or combinations of the above. Many of these types of cells can be fabricated on flexible substrates.

Additionally, concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a thickness range of about 1 nm to about 200 nm should be interpreted to include not only the explicitly recited limits of about 1 nm and about 200 nm, but also to include individual sizes such as but not limited to 2 nm, 3 nm, 4 nm, and sub-ranges such as 10 nm to 50 nm, 20 nm to 100 nm, etc. . . . .

The publications discussed or cited herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed. All publications mentioned herein are incorporated herein by reference to disclose and describe the structures and/or methods in connection with which the publications are cited. For example, U.S. Provisional Application Ser. No. 60/939,843 filed May 23, 2007 is fully incorporated herein by reference for all purposes.

While the above is a complete description of the preferred embodiment of the present invention, it is possible to use various alternatives, modifications and equivalents. Therefore, the scope of the present invention should be determined not with reference to the above description but should, instead, be determined with reference to the appended claims, along with their full scope of equivalents. Any feature, whether preferred or not, may be combined with any other feature, whether preferred or not. In the claims that follow, the indefinite article “A”, or “An” refers to a quantity of one or more of the item following the article, except where expressly stated otherwise. The appended claims are not to be interpreted as including means-plus-function limitations, unless such a limitation is explicitly recited in a given claim using the phrase “means for.”

What is claimed is:

1. An assembly for mounting a plurality of photovoltaic modules over an installation surface, the assembly comprising:
a plurality of non-roof penetrating grid supports configured to elevate a support grid above the installation surface.

2. An assembly for mounting a plurality of photovoltaic modules over a roof surface, the assembly comprising:
a plurality of non-roof penetrating grid supports configured to elevate the support grid above the roof surface; and
a plurality of grid-to-roof anchors that secure the entire support grid over the roof surface.

3. The assembly of claim 2 wherein the grid comprises of a rigid structure formed by rigidly coupling the plurality of elongate members together.

4. The assembly of claim 2 wherein the grid comprising a plurality of sections, wherein each section comprise of a plurality of elongate members rigidly connected together.

5. An assembly for mounting a plurality of photovoltaic modules over a roof surface, the assembly comprising:
a plurality of elongate metal rods, wherein the elongate metal rods are connected together to define a support grid;
a plurality of non-roof penetrating grid supports configured to elevate the support grid above the roof surface; and
a plurality of grid-to-roof anchors that secure the entire support grid over the roof surface, wherein the number of grid-to-roof anchors is less than about ¼ of the number of non-roof penetrating grid supports used to support the modules to minimize the number of locations where water may enter the roof surface.

6. The assembly of claim 5 wherein the elongate metal rods comprises of reinforcing steel bars (rebar).

7. The assembly of claim 5 wherein the elongate metal rods comprises of ribbed steel bars.

8. The assembly of claim 5 wherein the elongate metal rods comprises of solid cylindrical metal bars, approximately ⅛-3 inch diameter, made in varying lengths from 4′ to 20′.

9. The assembly of claim 5 wherein the elongate metal rods are epoxy coated.

10. The assembly of claim 5 wherein the support grid is defined by a plurality of metal rods arranged longitudinally and a plurality of metal rods arrange latitudinally.

11. The assembly of claim 5 wherein the support grid comprises of a rectangular array.

12. The assembly of claim 5 wherein the non-roof penetrating grid supports are located at intersections of longitudinally oriented metal rods and latitudinally oriented metal rods.

13. The assembly of claim 5 wherein the non-roof penetrating grid supports each include a substantially flat bottom surface to engage the roof surface.

14. The assembly of claim 5 wherein the non-roof penetrating grid supports each include a first cutout to receive a longitudinally oriented metal rod and to a second cutout to receive a latitudinally oriented metal rod.

15. The assembly of claim 5 wherein the non-roof penetrating grid supports are adjustable in height to address undulations in the roof surface while maintaining the support grid in a substantially flat configuration.

16. The assembly of claim 5 further comprising a plurality of photovoltaic device mounts to secure the photovoltaic devices over the support grid.

17. The assembly of claim 16 wherein the photovoltaic device mounts are mounted on the on-roof penetrating grid supports.

18. The assembly of claim 16 wherein the photovoltaic device mounts are mounted on the elongate metal rods that define the support grid.

19. The assembly of claim 16 wherein the photovoltaic device mounts are configured to engage two separate photovoltaic devices by securing one edge of one photovoltaic device and one edge of a different photovoltaic device.

20. The assembly of claim 16 wherein the photovoltaic device mounts clamp the photovoltaic device between one surface on the mount and one surface on the non-roof penetrating grid support.

21. The assembly of claim 5 wherein the photovoltaic device mounts connect the modules to the mounts using hinge connectors to allow for angular motion of the photovoltaic devices.

22. The assembly of claim 5 wherein the photovoltaic device mounts connect the modules to the mounts using press-fit connectors.

23. The assembly of claim 5 wherein the photovoltaic device mount comprises of an elevated section so that each photovoltaic device is mounted at an angle relative to horizontal.
